(19) United States
(12) Patent Application Publication
(10) Pub. No.: US 2003/0169960 A1
(43) Pub. Date: Sep. 11, 2003

(54) Mechanical optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/191,588

(22) Filed: Jul. 8, 2002

(30) Foreign Application Priority Data
Mar. 6, 2002 (TW) 91202526

(51) Int. Cl. G02B 6/35; G02B 6/32

(52) U.S. Cl. 385/16; 385/33

(57) ABSTRACT

A mechanical optical switch includes an input optical fiber, an input collimating lens, an aspherical lens and a plurality of output optical fibers all having a common optical axis. A rotating device rotates the aspherical lens. The aspherical lens has a planar end surface on one end for receiving and deflecting parallel light beams from the input collimating lens. An aspherical end surface on the other end focuses light on a given output optical fiber. In operation, light beams transmitted from the input optical fiber are selectively converged into a desired output optical fiber by rotating the aspherical lens by means of the rotating device.

### BACKGROUND OF THE INVENTION

1. Field of the Invention

The present invention relates to mechanical optical switches, and particularly to a one-to-many mechanical optical switch.

2. Description of Related Art

There are generally two types of optical switches in use today: electronic optical switches and mechanical optical switches. Mechanical optical switches are typically characterized as being either moving optical component switches or moving fiber switches.

Conventional moving fiber optical switches provide multiple-port switching, but are mechanically complex and expensive. Furthermore, most require fine alignment, which often requires frequent adjustment. For example, one such optical switch uses a moveable fiber connector plug having guide pins, and an array of fixed fiber connector receiver plugs having pin receptacles. In operation, the moveable plug is firstly transported to a desired position to mate with a fixed plug. The moveable plug is then pushed into the fixed plug, with the guide pins being inserted into the receptacles. This achieves precise alignment of the moveable plug. The switch is expensive to assemble, requires relatively high alignment tolerances, and therefore needs frequent adjustment.

U.S. Pat. No. 4,401,365 discloses a rotary-type optical switch in which a pair of opposing optical transmission path mounting members is disposed on the same rotational axis. One mounting member may be fixedly secured in a casing while the other member rotates on a central shaft. Alternatively, the mounting member may be directly connected to a motor so that one mounting member is rotatable with respect to the other as the shaft or mounting member is rotated by the motor. The mounting members each have a planar surface, the two surfaces closely opposing each other. Optical fibers are secured in each mounting member such that end faces of the optical fibers in each mounting member are concentric about the rotational axis of the mounting member and lie on respective phantom circles having the same radii. However, precise alignment of the opposing optical fibers in such a switch is very critical and depends on precision of the components of the switch. This requires the components to be made to very precise tolerances along with exacting manufacturing processes.

### SUMMARY OF THE INVENTION

Accordingly, an object of the present invention is to provide a one-to-many mechanical optical switch which is simple and which is easy to manufacture.

In order to achieve the object set forth above, a one-to-many mechanical optical switch in accordance with the present invention comprises an input port having an input optical fiber, an output port having a plurality of output optical fibers, a switching device disposed between the input and output optical fibers, and a driving means for driving the switching device. The input port, the switching device and the output port are sequentially arranged along a common optical axis on a base. The output optical fibers are arranged concentrically relative to the optical axis. The switching device comprises a cogwheel having a tubular axle and an aspherical lens retained therein. The aspherical lens has two opposite ends, a first end having a slanted surface for deflecting parallel light beams transmitted from the input optical fiber. A second end has a convex end surface which focuses the light beams transmitted through the lens to a focal point thereof. The focal point is slightly shifted relative to the optical axis by an offset as a result of the slanted end surface. A distance between a central axis of each output optical fiber and the optical axis is substantially equal to the above-mentioned offset.

In operation, the cogwheel of the switching device is driven by the driving means. The aspherical lens carried in the cogwheel therefore rotates with the cogwheel relative to the optical axis. The converged light beams are thereby switched to be coupled into a desired output optical fiber.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a mechanical optical switch in accordance with a preferred embodiment of the present invention;

FIG. 2 is a cross-sectional view taken along line II-II of FIG. 1;

FIG. 3 is a cross-sectional view taken along line III-III of FIG. 1;

FIG. 4 is an essential optical paths diagram of the optical switch of FIG. 1, in a first operational state of the optical switch; and

FIG. 5 is an essential optical paths diagram of the optical switch of FIG l, in a second operational state of the optical switch.

### DETAILED DESCRIPTION OF THE PRESENT INVENTION

Reference will now be made to the drawings to describe the present invention in detail.

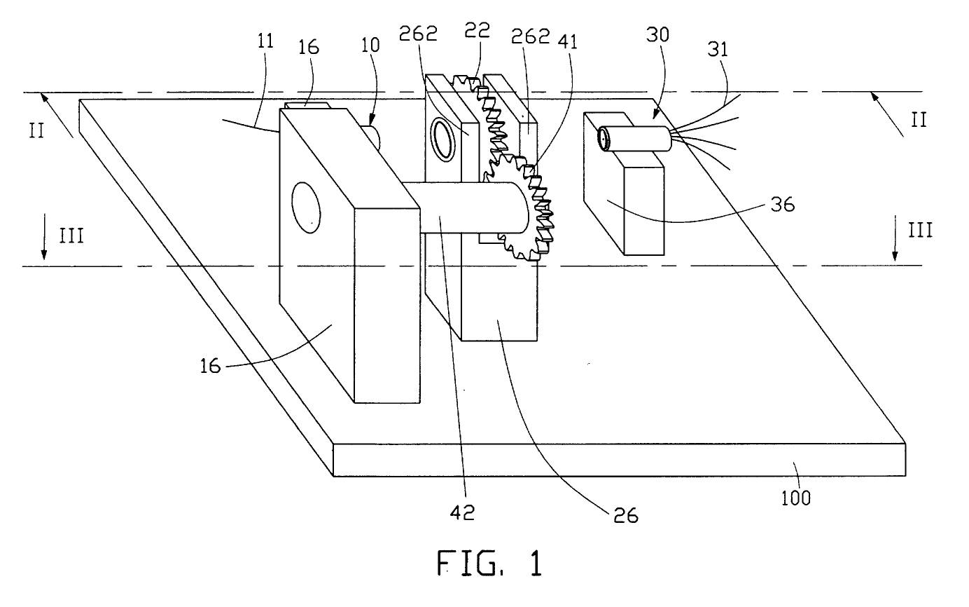

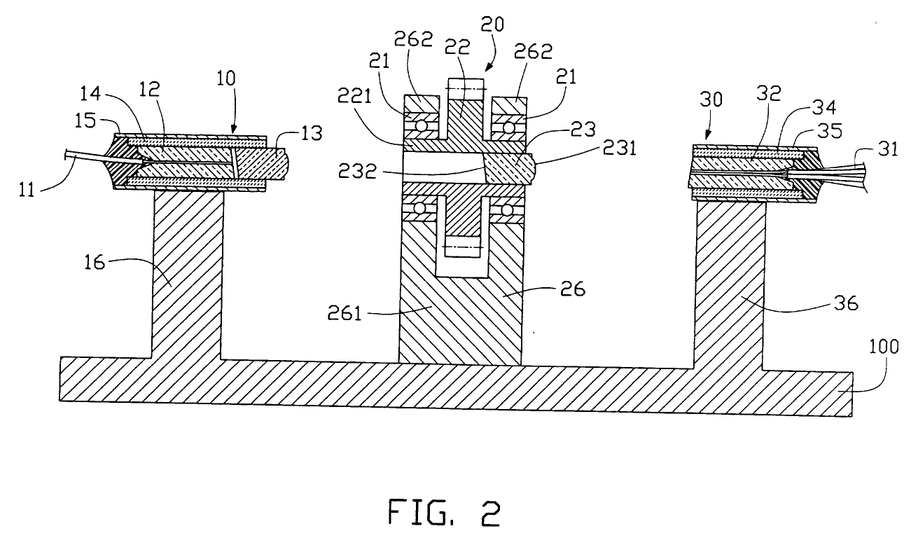

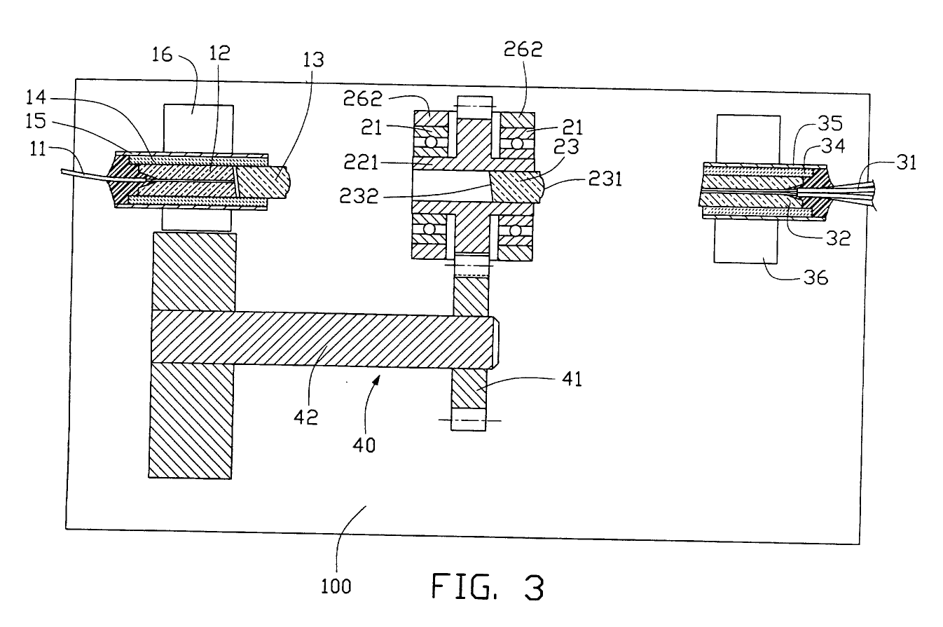

Referring to FIGS. 1-3, a on-to-many mechanical optical switch in accordance with a preferred embodiment of the present invention comprises an input port 10, a switching device 20, an output port 30 and driving means 40.

The input port 10 comprises an input optical fiber 11 having a central axis, a first ferrule 12 retaining an end section of the input optical fiber 11, an input collimating lens 13 arranged in coaxial relationship with the input optical fiber 11, a first sleeve 14, and a first metal tube 15. The input collimating lens 13 can be, for instance, a Graded Index lens (GRIN lens) or a molded lens. The first sleeve 14 is generally made of silica. The first sleeve 14 retains the first ferrule 12, with the input optical fiber 11, and the input collimating lens 13 therein, and the first ferrule 14 is itself enclosed by the first metal tube 15. The input port 10 is fixed in a first support 16 that is formed on a base 100.

The output port 30 comprises a plurality of output optical fibers 31, a second ferrule 32 retaining the output optical fibers 31, a second ferrule 34, and a second metal tube 35. The output optical fibers 31 are bundled together. End sections of the output optical fibers 31 are arranged evenly around a central axis of the second ferrule 32, and equidistant from the central axis. The second sleeve 34 retains the second ferrule 32 with the output optical fibers 31 therein, and the second sleeve 34 is itself enclosed by the second metal tube 35. The output port 30 is fixed in a second support 36 that is formed on the base 100.

The switching device 20 comprises a pair of roller bearings 21, a cogwheel 22, and an aspherical lens 23. A third support 26 is formed between the first and second supports 16, 36. The third support 26 comprises a lower base portion 261, and two opposite block supports 262 extending upwardly from the lower base portion 261. The roller bearings 21 are respectively retained in the opposite block supports 262. The cogwheel 22 has a tubular axle 221, for retaining the aspherical lens 23 therein. Opposite ends of the tubular axle 221 respectively engage with the roller bearings 21. The aspherical lens 23 has an aspherical end surface 231 adapted for focusing parallel incident light beams to a focal point. A planar end surface 232 of the aspherical lens 23 is slanted such that the focal point of the aspherical lens 23 is slightly offset relative to its optical axis. The offset is accurately predetermined to be substantially equal to a distance between a central axis of each output optical fiber 31 and the central axis of the second ferrule 32 of the output port 30. The central axis of the input optical fiber 11, the optical axis of the aspherical lens 23 and the central axis of the second ferrule 32 of the output port 30 all share a common axis.

The driving means 40 comprises a driving gearwheel 41 for meshing with the cogwheel 22 of the switching device 20, a shaft 42 fixedly engaged in the driving gearwheel 41, and an electrical controlling mechanism (not shown) controlling rotary motion of the shaft 42. The driving means 40 is mounted on the base 100 adjacent the switching device 20, for driving the switching device 20 to rotate.

It should be noted that for the purposes of illustrating the present invention, the above-described particular mechanism has been selected to effect rotation of the aspherical lens 23. Said mechanism is not critical to practice the present invention. A variety of conventional mechanisms are known to those skilled in the art, and may be suitably adopted. The switching device 20 and the driving means 40 are exemplified herein for illustration purposes only, and are not intended to limit the present invention.

In assembly, the driving gearwheel 41 is meshed with the cogwheel 22 of the switching device 20. The output port 30 is spaced apart from the aspherical lens 23 at a predetermined distance such that the focal point of the aspherical lens 23 can be substantially located within an end surface of each output optical fiber 31 when the aspherical lens 23 is rotated to a corresponding position.

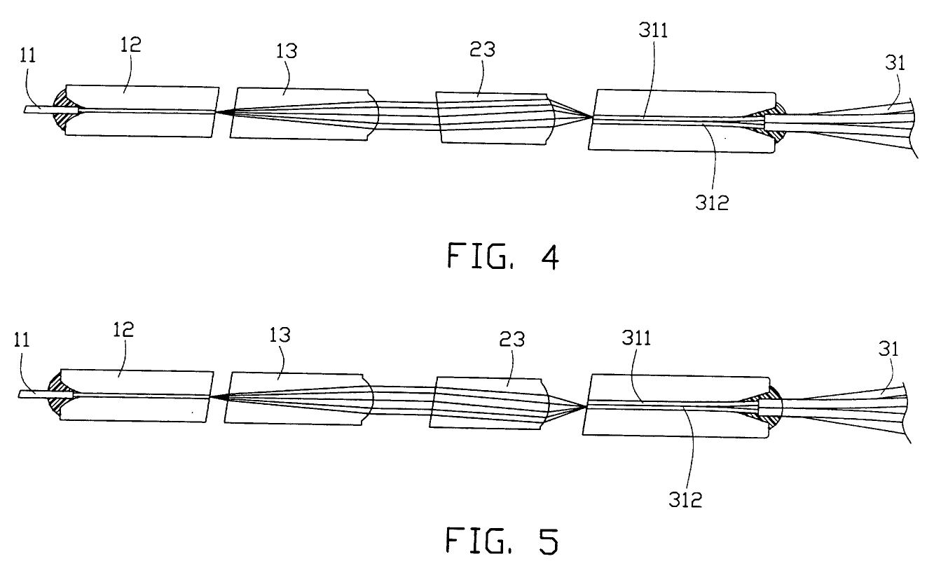

Referring to FIG. 4, in operation, light beams transmitted from the input optical fiber 11 are collimated into parallel beams by the input collimating lens 13 of the input port 10. The parallel beams become incident on the planar end surface 232 of the aspherical lens 23, and are then deflected and converged to the focal point by the aspherical lens 23. The converged light beams are then substantially collected by one of the output optical fibers 31, namely output optical fiber 311. Referring to FIG. 5, when the driving means 40 drives the driving gearwheel 41 to rotate, the cogwheel 22 accordingly rotates the aspherical lens 23 relative to the optical axis of the aspherical lens 23. The aspherical lens 23 is rotated a suitable angle. The converged light beams are thus switched to be substantially collected by another of the output optical fibers 31, namely output optical fiber 312.

While the present invention has been described with reference to particular embodiments, the description is illustrative of the invention and is not to be construed as limiting the invention. Therefore, various modifications to the present invention can be made to the preferred embodiments by those skilled in the art without departing from the true spirit and scope of the invention as defined by the appended claims.

1. A mechanical optical switch comprising:
A switching lens having a first side and a second side and having an optical axis which intersects the first side and the second side, the switching lens being rotatable about the optical axis, the switching lens having a planar slanted end surface on the first side such that a focal point of the switching lens on the second side is offset relative to the optical axis;
an input optical fiber adjacent an input collimating lens, the input optical fiber, the input collimating lens and the switching lens colinear optical axes, the input collimating lens being mounted on the first side of the switching lens;
a plurality of output optical fibers disposed a distance from the second side of the switching lens, end sections of the output optical fibers being arranged around the optical axis of the lens, wherein a distance between a central axis of each of the output optical fiber and the optical axis corresponds to offset of the focal point of the switching lens; and
driving means for rotating the switching lens about its optical axis, the driving means being adapted to rotate the switching lens such that the focal point of the switching lens is selectively moved to be located at an end surface of any selected one of the output optical fibers, whereby light beams transmitting from the input optical fiber are directed into a selected one of the output optical fibers.

2. The mechanical optical switch as described in claim 1, wherein the lens is an aspherical lens.

3. The mechanical optical switch as described in claim 1, wherein a switching means comprises a cogwheel, and the switching lens, and the switching lens is arranged in the cogwheel whereby the optical axis of the switching lens is substantially coaxial with an axis of rotation of the cogwheel.

4. A mechanical optical switch comprising:
an aspherical lens adapted to focusing parallel incident light beams to a focal point, the aspherical lens having an optical axis, an end surface of a first side of the aspherical lens being slanted such that the focal point is offset relative to the optical axis;
a first optical fiber;
an input collimating lens interposed coaxially between the first optical fiber and the aspherical lens;
a plurality of second optical fibers arranged adjacent an opposite second side of the aspherical lens, end sections of the output optical fibers being arranged around the optical axis, a distance between a central axis of each of the output optical fibers and the optical axis corresponding to the offset of the focal point of the aspherical lens; and
driving means for rotating the aspherical lens about its optical axis, thereby selectively focusing light beams transmitted from the input optical fiber into a desired one of the output optical fibers.

5. The mechanical optical switch as described in claim 4, wherein a switching means comprises a cogwheel and the aspherical lens fixed to the cogwheel.

6. The mechanical optical switch as described in claim 5, wherein the cogwheel comprises a tubular axle retaining the aspherical lens therein.

7. The mechanical optical switch as described in claim 5, wherein the driving means further comprises a driving gear meshing with the cogwheel.

8. An optical 1×N switch comprising:
an lens focusing parallel light beams to a focal point which is laterally offset from a center optical axis of said lens;
an input collimating lens spatially coaxially disposed on one side of said lens with an input fiber closely located around thereof one end opposite to said lens, said input collimating lens converting a spot light beam emitted from the input fiber to said parallel light beams; and
a plurality of output fibers located on the other sides of said lens, said output fibers arranged along a periphery of a center axis which is axially aligned with said center optical axis; wherein
said lens is rotated about said center optical axis to have said focal point aligned with the selective one of said output fibers.
